(19) United States
(12) Patent Application Publication
(10) Pub. No.: US 2015/0316812 A1
(43) Pub. Date: Nov. 5, 2015

(54) DISPLAY DEVICE AND TOUCH PANEL-EQUIPPED DISPLAY DEVICE

(71) Applicant: SHARP KABUSHIKI KAISHA, Osaka-shi, Osaka (JP)

(72) Inventors: Masashi MAYUMI, Osaka (JP); Mikihiro NOMA, Osaka (JP)

(73) Assignee: Sharp Kabushiki Kaisha, Osaka (JP)

(21) Appl. No.: 14/651,177

(22) PCT Filed: Dec. 9, 2013
(86) PCT No.: PCT/JP2013/082969

§ 371 Date: Jun. 10, 2015

(30) Foreign Application Priority Data
Dec. 14, 2012 (JP) 2012-273976

(51) Int. Cl. G02F 1/1333; G06F 3/041

(52) U.S. Cl. CPC G02F 1/133308; G06F 3/0412; G02F 1/13338; G06F 2203/04107; G02F 2001/133334

(57) ABSTRACT

The present invention reduces driving noise and provides a display device that can be used in combination with a high-precision touch panel. A display device includes: a first substrate; a second substrate facing the first substrate; a shield layer provided on the surface of the first substrate opposite to the surface facing the second substrate; and a ground terminal that is electrically connected to the shield layer. The shield layer includes a transparent conductive film and a metal film that is provided on at least one portion of the periphery of the first substrate and contacts the transparent conductive film. Shield resistance is defined as the maximum resistance between the ground terminal and an arbitrary point on the transparent conductive film. The shield resistance is less than 1000Ω, and the noise on the surface of the transparent conductive film is less than or equal to 1V.

### TECHNICAL FIELD

The present invention relates to a display device and a touch panel-equipped display device.

### BACKGROUND ART

As touch panel-equipped display devices become increasingly thinner, touch panel controllers receive more electrical noise that comes from driving the display device, thereby reducing the signal-to-noise ratio (SNR) in the touch panel. A reduction in this SNR makes it more difficult to achieve functionalities such as pen input and hover input.

Japanese Patent Application Laid-Open Publication No. 2011-95451 discloses an in-plane switching liquid crystal display device equipped with a conductive film that acts as an electrostatic shield.

### SUMMARY OF THE INVENTION

In the device disclosed in Japanese Patent Application Laid-Open Publication No. 2011-95451, however, a sufficient shielding effect cannot be achieved because the resistance of the transparent conductive film is too high.

The present invention aims to reduce driving noise and to provide a display device that can be used in combination with a high-precision touch panel, as well as to provide such a touch panel-equipped display device.

A display device of the present invention includes: a first substrate; a second substrate facing the first substrate; a shield layer provided on a surface of the first substrate opposite to the second substrate; and a ground terminal electrically connected to the shield layer, wherein the shield layer includes: a transparent conductive film; and a metal film formed on at least one portion of a periphery of the first substrate such that the metal film contacts the transparent conductive film, wherein a shield resistance, being defined as a maximum resistance value between the ground terminal and any point on the transparent conductive film, is less than 1000Ω, and wherein noise on the transparent conductive film is less than or equal to 1V.

The present invention reduces driving noise and provides a display device that can be used in combination with a high-precision touch panel as well as such a touch panel-equipped display device.

### BRIEF DESCRIPTION OF THE DRAWINGS

FIG. 1 is a cross-sectional view schematically illustrating a configuration of a touch panel-equipped display device according to an embodiment of the present invention.

FIG. 2 is a plan view illustrating a portion of a second substrate.

FIG. 3 is a graph illustrating the relationship between touch panel driving frequency and the magnitude of noise received by a touch panel controller.

FIG. 4 is a cross-sectional view schematically illustrating a configuration of a display device provided with the touch panel-equipped display device according to an embodiment of the present invention.

FIG. 5 is a cross-sectional view taken along line V-V in FIG. 4.

FIG. 6A is a plan view illustrating an example configuration of a metal film of a shield layer.

FIG. 6B is a plan view illustrating a shield layer that does not include a metal film.

FIG. 6C is a plan view illustrating another example configuration of a metal film of a shield layer.

FIG. 6D is a plan view illustrating another example configuration of a metal film of a shield layer.

FIG. 6E is a plan view illustrating another example configuration of a metal film of a shield layer.

FIG. 6F is a plan view illustrating another example configuration of a metal film of a shield layer.

FIG. 6G is a plan view illustrating another example configuration of a metal film of a shield layer.

FIG. 7 is a schematic of a measuring environment for measuring the relationship between shield resistance and surface noise.

FIG. 8A is a waveform diagram illustrating a measurement taken from an insulating sheet.

FIG. 8B is a waveform diagram illustrating a measurement taken when a variable resistance unit was set to a value of 1000Ω.

FIG. 8C is a waveform diagram illustrating a measurement taken when the variable resistance unit was set to a value of 100Ω.

FIG. 8D is a waveform diagram illustrating a measurement taken when the variable resistance unit was set to a value of 0Ω.

FIG. 9 is a graph illustrating the relationship between the resistance to which the variable resistance unit was set and surface noise Vpp for a variety of voltages applied to a metal plate.

FIG. 10 is a table of variable resistance values in the variable resistance unit at which surface noise Vpp was less than or equal to 1V when a prescribed voltage was applied to a metal plate and the variable resistance value was progressively decreased.

FIG. 11 is a graph of the information in FIG. 10.

### DETAILED DESCRIPTION OF EMBODIMENTS

A display device according to one embodiment of the present invention includes: a first substrate; a second substrate facing the first substrate; a shield layer provided on the surface of the first substrate opposite to the surface facing the second substrate; and a ground terminal that is electrically connected to the shield layer. The shield layer includes a transparent conductive film and a metal film that is provided on at least one portion of the periphery of the first substrate and contacts the transparent conductive film. Here, shield resistance is defined as the maximum resistance between the ground terminal and an arbitrary point on the transparent conductive film. In a first configuration of the present embodiment, the shield resistance is less than 1000Ω and the noise on the surface of the transparent conductive film is less than or equal to 1V.

In this configuration, the display device includes a shield layer provided on the surface of the first substrate opposite to the surface facing the second substrate. The shield layer blocks electric fields originating from beyond the shield layer on the second substrate side. The shield layer includes a transparent conductive film and a metal film. The shield resistance can be reduced by arranging the metal film on at least one portion of the periphery of the first substrate such that the metal film contacts the transparent conductive film.

In the first configuration of the present embodiment, it is preferable that the metal film be arranged along one side, two sides, or three sides of the first substrate. Such a configuration represents a second configuration of the present embodiment.

In the second configuration of the present embodiment, the metal film is not provided along at least one side of the first substrate. This makes it possible to make the frame of the display device narrower.

In the first and second configurations of the present embodiment, it is preferable that the shield resistance be less than or equal to 100Ω. Such a configuration represents a third configuration of the present embodiment.

The touch panel-equipped display device according to an embodiment of the present invention includes a display device configured in one of the abovementioned first to third configurations and a touch panel.

### Embodiment

An embodiment of the present invention will be described in detail below with reference to figures. The same reference characters are used for components that are the same or equivalent in each of the figures, and duplicate descriptions of such components are omitted. Moreover, in the figures referenced below, configurations of the present invention are depicted in a simplified or schematic style for purposes of explanation. Some components are not depicted in the figures. Furthermore, the dimensional proportions depicted between the components in the figures are not necessarily the actual dimensional proportions between components of the present invention in an actual configuration thereof.

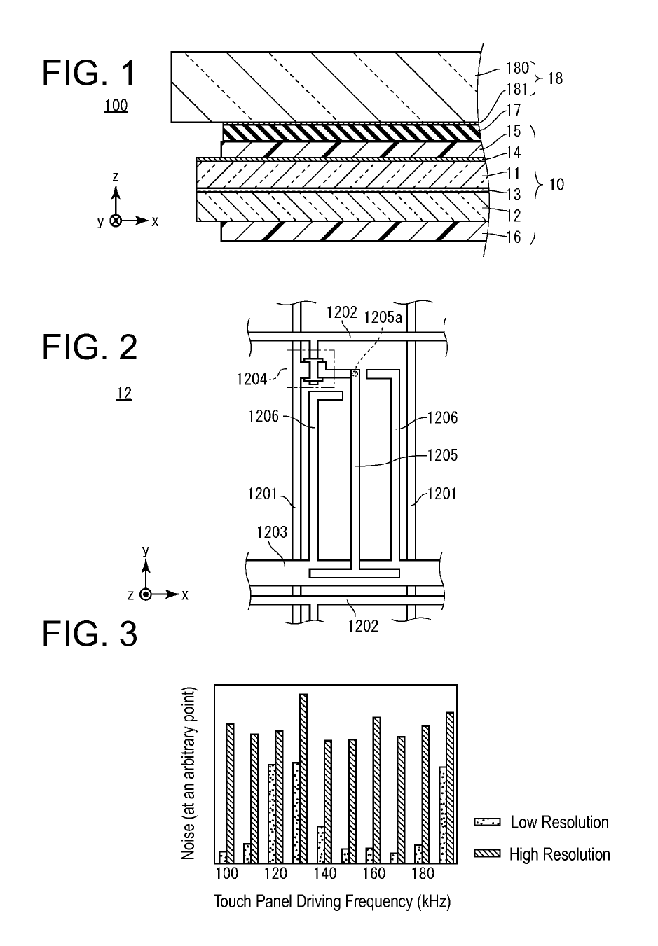

FIG. 1 is a cross-sectional view schematically illustrating a configuration of a touch panel-equipped display device 100 according to an embodiment of the present invention. The touch panel-equipped display device 100 includes a display device 10, an optically clear adhesive (OCA) 17, and a touch panel 18. The display device 10 and the touch panel 18 are fixed to one another by the OCA 17.

The display device 10 includes a first substrate 11, a second substrate 12, a liquid crystal layer 13, a shield layer 14, and polarizing plates 15 and 16. The first substrate 11 and the second substrate 12 are arranged facing one another. The liquid crystal layer 13 is sandwiched between the first substrate 11 and the second substrate 12. The shield layer 14 is provided on the surface of the first substrate 11 opposite to the surface facing the second substrate 12. The polarizing plate 15 is provided on top of the shield layer 14. The polarizing plate 16 is provided on the surface of the second substrate 12 opposite to the surface facing the first substrate 11.

The first substrate 11 includes a black matrix and a color filter, although these components are not shown in the figures.

FIG. 2 is a plan view illustrating a portion of the second substrate 12. The second substrate 12 includes source lines 1201, gate lines 1202, capacitance lines 1203, thin-film transistors (TFTs) 1204, pixel electrodes 1205, and common electrodes 1206.

The gate lines 1202 and the capacitance lines 1203 are formed parallel to one another. The source lines 1201 are formed orthogonal to the gate lines 1202 and the capacitance lines 1203 when viewed in a plan view. The TFTs 1204 are formed near the intersections between the source lines 1201 and the gate lines 1202. The source electrodes of the TFTs 1204 are connected to the source lines 1201, and the gate electrodes of the TFTs 1204 are connected to the gate lines 1202. The drain electrodes of the TFTs 1204 are connected to the pixel electrodes 1205 via contact holes 1205a.

The common electrodes 1206 are connected to the capacitance lines 1203. Moreover, an insulating layer (not shown in the figure) is formed between the pixel electrodes 1205 and the capacitance lines 1203, thereby forming a storage capacitance.

In the liquid crystal display device 10, the orientation of liquid crystal molecules in the liquid crystal layer 13 is controlled using the difference in electric potential between the pixel electrodes 1205 and the common electrodes 1206. In other words, the display device 10 is an in-plane switching (IPS) liquid crystal display device in which the liquid crystal molecules are driven using in-plane electric fields.

The shield layer 14 includes a transparent conductive film and a metal film. The configuration of the shield layer 14 will be described in more detail later. In the present embodiment, the transparent conductive film and the metal film are formed on the first substrate 11 using a sputtering process or the like. Moreover, the shield layer 14 may be configured by forming a transparent conductive film and a metal film on a base material separate from the first substrate and then overlaying the shield layer 14 assembly on the first substrate 11.

The touch panel 18 includes a substrate 180 and sensor electrodes 181 formed on the display device 10-side surface of the substrate 180. The touch panel 18 detects the position at which a finger or the like touches the surface of the substrate 180 opposite to the display device 10-side surface by detecting the electrostatic capacitance that forms between the sensor electrodes 181. In other words, the touch panel 18 is a capacitive touch panel.

The touch panel 18 is controlled using a touch panel controller (not shown in the figures). The touch panel controller receives interference in the form of electrical noise from the display device 10. FIG. 3 is a graph illustrating the relationship between touch panel driving frequency and the magnitude of noise received by the touch panel controller. In FIG. 3, the magnitude of noise received by the touch panel controller when the display device 10 is a low-resolution device is shown using the dotted bars, and the magnitude of noise received by the touch panel controller when the display device 10 is a high-resolution device is shown using the striped bars.

The touch panel driving frequency is determined by selecting a frequency band in which the magnitude of noise from the display device 10 is relatively small. However, as shown in FIG. 3, when the display device 10 is a high-resolution device, the magnitude of the noise is higher at all frequency bands. In other words, there are no frequency bands in which the magnitude of noise from the display device 10 is relatively small. Therefore, in the present embodiment, the shield layer 14 is used to decrease the magnitude of the noise from the display device 10.

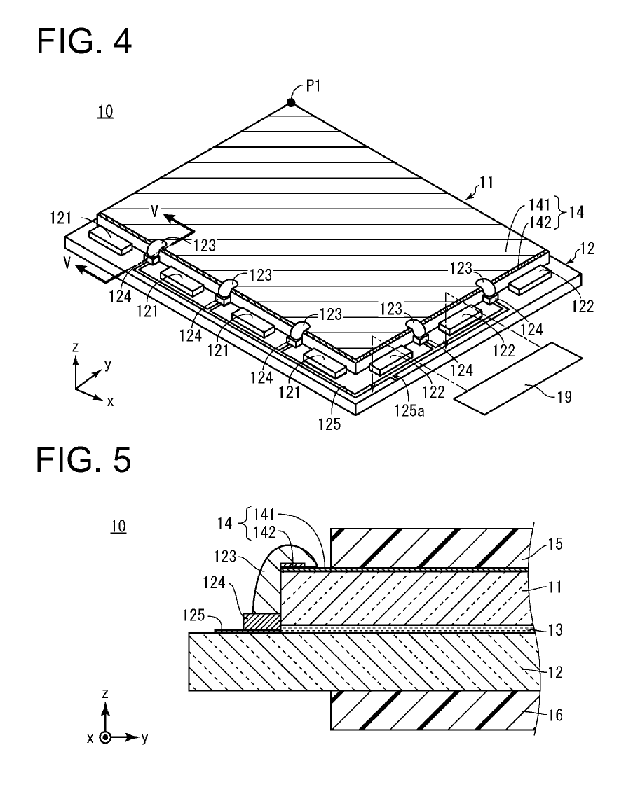

FIG. 4 schematically illustrates a configuration of the display device 10. FIG. 5 is a cross-sectional view taken along line V-V in FIG. 4. The display device 10 further includes source drivers 121, gate drivers 122, conductive paste members 123, ground pads 124, a ground line 125, and a flexible printed circuit (FPC) 19. Moreover, in FIG. 4 cross-hatching patterns are applied to the transparent conductive film 141 and the metal film 142 of the shield layer 14. It should be noted that the polarizing plates 15 and 16 are not shown in FIG. 4.

As shown in FIG. 4, the second substrate 12 has a larger area than the first substrate 11, leaving a portion of the periphery of the second substrate 12 exposed. The source drivers 121 and the gate drivers 122 are mounted on the exposed periphery of the second substrate 12 using a chip on glass (COG) technology. The source drivers 121 and the gate drivers 122 may also be mounted using a tape-automated bonding (TAB) technology.

The ground line 125 and another wiring line (not shown in the figure) are formed on the second substrate 12. At one portion of the second substrate 12, a ground terminal 125a is formed in the ground line 125, and another terminal (not shown in the figure) is formed in the other wiring line. The ground terminal 125a and the other terminal are connected to the FPC 19.

The ground pads 124 are formed in contact with the ground line 125. The ground pads 124 are electrically connected to the shield layer 14 via the conductive paste members 123.

As described above, the shield layer 14 includes the transparent conductive film 141 and the metal film 142.

The transparent conductive film 141 is formed covering essentially the entire surface of the first substrate 11 opposite to the liquid crystal layer 13-side surface. It is preferable that the transparent conductive film 141 have a high transmittance. The transparent conductive film 141 may be formed using indium tin oxide (ITO), for example. The transparent conductive film 141 is formed using a sputtering process or a chemical vapor deposition (CVD) process, for example.

The metal film 142 is formed in contact with the transparent conductive film 141 along two edges of the first substrate 11. More specifically, the metal film 142 is formed along the positive X direction-side edge and the negative Y direction-side edge of the first substrate 11 (according to the coordinate axes shown in FIG. 4). Moreover, the metal film 142 may be formed on at least one portion of the periphery of the first substrate 11. It is preferable that the metal film 142 be formed outside of the display region of the display device 10. Other examples of configurations for the metal film 142 will be described later. The metal film 142 is an Ag alloy film, for example. The metal film 142 is formed using a sputtering process and patterned using a photolithography process, for example.

In the configuration described above, the transparent conductive film 141, the metal film 142, the conductive paste members 123, the ground pads 124, the ground line 125, and the ground terminal 125a are all electrically connected to one another.

Here, the shield resistance is defined as the maximum resistance between the ground terminal 125a and an arbitrary point on the transparent conductive film 141. In the present embodiment, the theoretically largest resistance is between the ground terminal 125a and the point P1 shown in FIG. 4. Therefore, in the present embodiment the shield resistance is the resistance between the ground terminal 125a and the point P1.

The shield resistance of the display device 10 will be described in more detail later but has a value less than 1000Ω, for example. It is preferable that the shield resistance be less than 100Ω, and it is more preferable that the shield resistance be less than 50Ω.

It is preferable that the resistance of the transparent conductive film 141, the metal film 142, the conductive paste members 123, the ground pads 124, and the ground line 125 be small so that the shield resistance is also small.

It is preferable that the sheet resistance of the transparent conductive film 141 be less than or equal to 35Ω/sq, and it is more preferable that the sheet resistance of the transparent conductive film 141 be less than or equal to 20Ω/sq.

It is preferable that the number of ground pads 124 be large, and it is preferable that the area of each ground pad 124 also be large. Similarly, it is preferable that the cross-sectional area of the ground line 125 be large.

It is preferable that the metal film 142 have a large width in order to reduce the shield resistance. On the other hand, it is not preferable that the width of the metal film 142 be large due to the associated difficulty of making the frame of the display device 10 narrower.

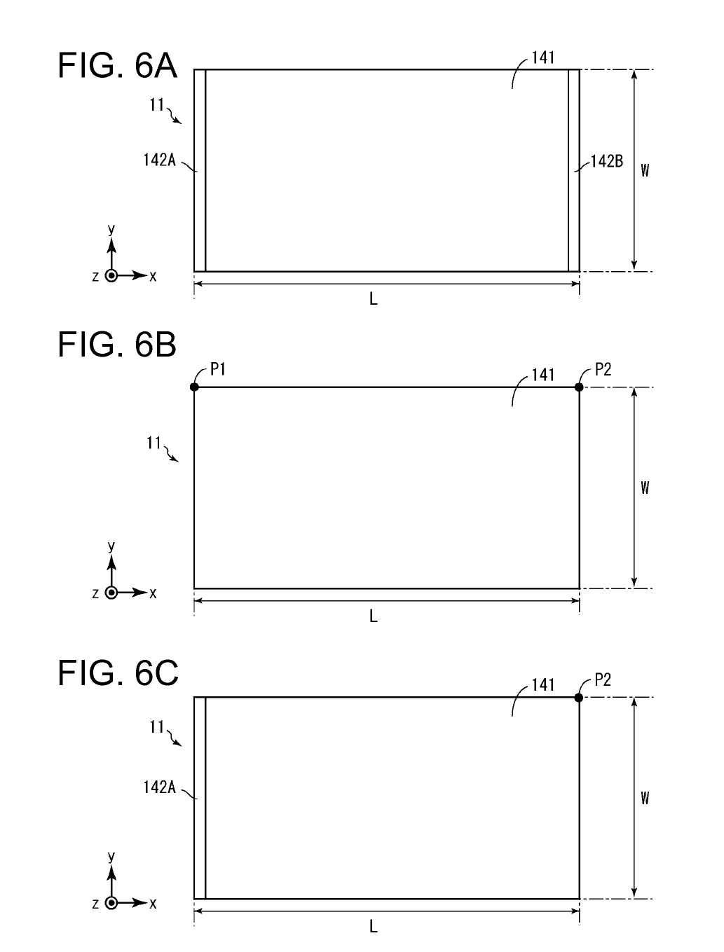

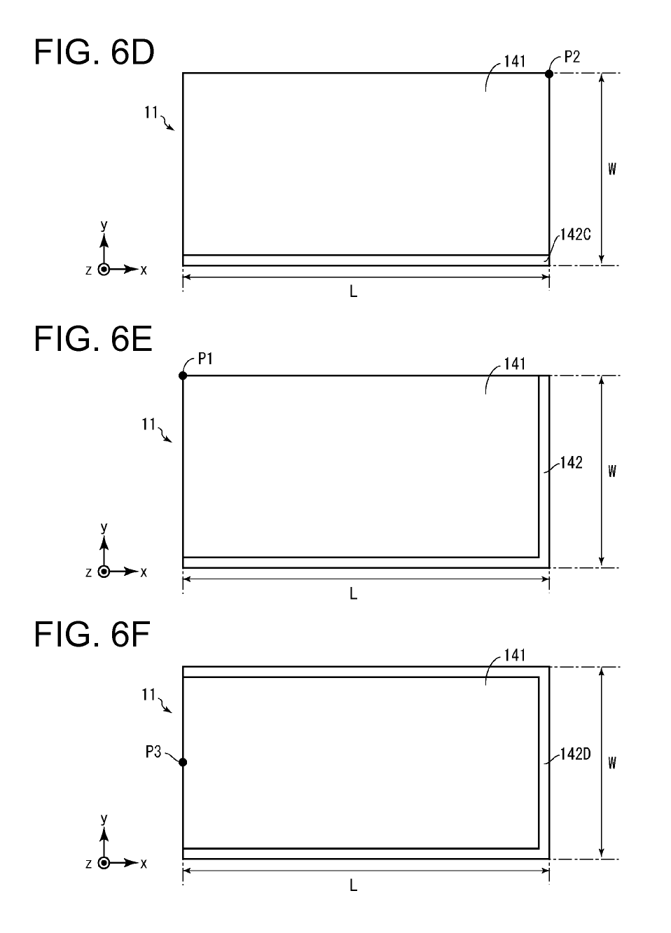

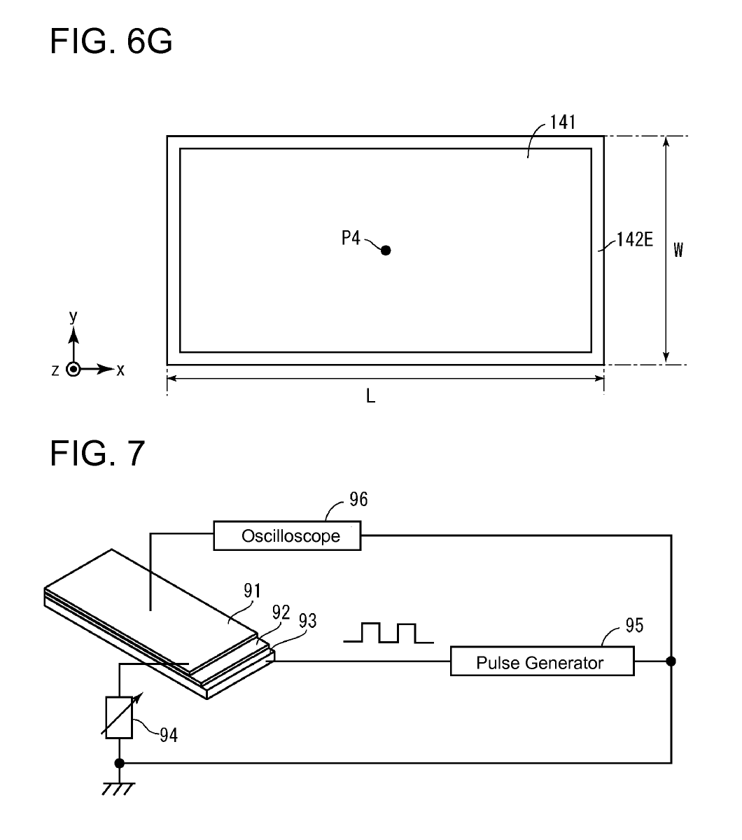

Next, examples of configurations for the metal film 142 as well as the shield resistance associated with each will be described with reference to FIGS. 6A to 6G.

FIG. 6A is a plan view illustrating an example configuration of the metal film 142. In FIG. 6A, the metal film 142 is replaced by two metal films 142A and 142B. The metal film 142A is formed along the negative X direction-side edge of the first substrate 11, and the metal film 142B is formed along the positive X direction-side edge of the first substrate 11.

Here, the resistance R between the metal film 142A and the metal film 142B can be written as R=ρ×L/(W×t), where L is the length of the first substrate 11 in the X direction, W is the width of the first substrate 11 in the Y direction, ρ is the resistivity of the transparent conductive film 141, and t is the thickness of the transparent conductive film 141. Moreover, by letting the sheet resistance ρₛ be ρₛ=ρ/t, the resistance R can be simplified to R=ρₛ×L/W.

When W=64 mm, L=122 mm, ρ=2.8×10⁻⁶Ωcm⁻¹, and t=140 nm, for example, R≈38Ω.

FIG. 6B is a plan view illustrating a configuration that does not include a metal film 142. In this case, the resistance R1 from the point P1 to the point P2 is R1=3.43×R≈131Ω.

FIG. 6C is a plan view illustrating another example configuration of the metal film 142. In FIG. 6C, the metal film 142 is replaced by a metal film 142A. In this case, the resistance R2 from the metal film 142A to the point P2 is R2=1.81×R≈69Ω.

FIG. 6D is a plan view illustrating another example configuration of the metal film 142. In FIG. 6D, the metal film 142 is replaced by a metal film 142C. The metal film 142C is formed along the negative Y direction-side edge of the first substrate 11. In this case, the resistance R3 from the metal film 142C to the point P2 is R3=0.88×R≈34Ω.

FIG. 6E is a plan view illustrating the same configuration shown in FIG. 4 for the metal film 142. In this case, the resistance R4 from the metal film 142 to the point P1 is R4=0.59×R≈22Ω.

FIG. 6F is a plan view illustrating another example configuration of the metal film 142. In FIG. 6F, the metal film 142 is replaced by a metal film 142D. The metal film 142D is formed along three edges of the first substrate 11: the positive and negative Y direction-side edges and the positive X direction-side edge. In this case, the resistance R5 from the metal film 142D to the point P3 is R5=0.16×R≈6.1Ω.

FIG. 6G is a plan view illustrating another example configuration of the metal film 142. In FIG. 6G, the metal film 142 is replaced by a metal film 142E. The metal film 142E is formed along all four edges of the first substrate 11. In this case, the resistance R6 from the metal film 142E to the point P4 is R6=0.1×R≈3.8Ω.

As described above, when the metal film is formed along more edges of the first substrate 11, the resistance decreases. On the other hand, it is preferable that the metal film be formed along as few of the edges of the first substrate 11 as possible in order to facilitate making the frame of the display device 10 narrower. Furthermore, when the metal film 142 is formed along all four edges of the first substrate 11 (the configuration with the metal film 142E shown in FIG. 6G), the metal film 142 essentially acts as a loop antenna and amplifies any noise present.

The inventor of the present invention measured the relationship between shield resistance and surface noise using the procedure described below. FIG. 7 is a schematic of a measuring environment for measuring this relationship. As shown in FIG. 7, an insulating sheet 92 is arranged on top of a metal plate 93, and a conductive film 91 is formed on top of the metal plate 93 as a mockup of the shield layer 14. The conductive film 91 is electrically grounded via a variable resistance unit 94. A pulse generator 95 generates a square wave that is applied to the metal plate 93, imitating a driving pattern that would be used to drive the common electrodes 1206. A probe of an oscilloscope 96 is applied to the conductive film 91 or to the insulating sheet 92 to measure the magnitude of surface noise present.

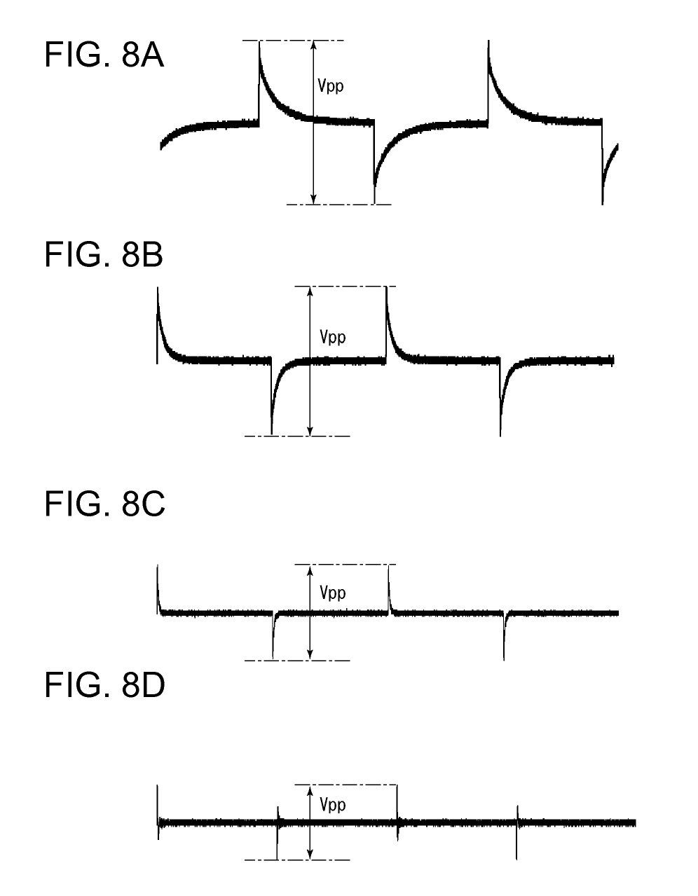

FIGS. 8A to 8G are waveform diagrams illustrating measurements taken when a 5V square wave was applied to the metal plate 93.

FIG. 8A is a waveform diagram illustrating a measurement taken from the insulating sheet 92. This waveform corresponds to the surface noise that would be present in a case in which the display device 10 does not include the shield layer 14. The surface noise Vpp (peak to peak voltage) was 10.2V.

FIG. 8B is a waveform diagram illustrating a measurement taken when the variable resistance unit 94 was set to 1000Ω. This waveform corresponds to the surface noise that would be present if the shield resistance of the display device 10 was 1000Ω. Here, the surface noise Vpp was 9.36V.

FIG. 8C is a waveform diagram illustrating a measurement taken when the variable resistance unit 94 was set to 100Ω. This waveform corresponds to the surface noise that would be present if the shield resistance of the display device 10 was 100Ω. Here, the surface noise Vpp was 5.92V.

FIG. 8D is a waveform diagram illustrating a measurement taken when the variable resistance unit 94 was set to 0Ω. This waveform corresponds to the surface noise that would be present if the shield resistance of the display device 10 was 0Ω. Here, the surface noise Vpp was 4.56V.

As described above, as the resistance of the variable resistance unit 94 is decreased, the magnitude of the surface noise also decreases. Moreover, the more the resistance of the variable resistance unit 94 is decreased, the less time it takes for the surface noise to decrease after peaking. In other words, in the display device 10, the more the shield resistance is decreased, the more the magnitude of the surface noise decreases, and the less time it takes for the surface noise to decrease after peaking.

Furthermore, the less the time it takes for the surface noise to decrease after peaking, the longer the period of time over which the surface noise remains at a nominal value. This is advantageous because if the time it takes for the surface noise to decrease after peaking can be reduced, the touch panel controller can be driven in synchronization with the display device 10 by driving the touch panel 18 during the periods of time in which the surface noise is smallest.

The following may be done to reduce the shield resistance, for example. (A) The resistance of the transparent conductive film 141, the metal film 142, the conductive paste members 123, the ground pads 124, and the ground line 125 may be reduced. (B) The number of ground pads 124 used may be increased. The area of each of the ground pads 124 may be increased. The cross-sectional area of the ground line 125 may be increased. (C) The width of the metal film 142 may be increased. The number of edges along which the metal film 142 is formed may be increased.

In case (A), however, there is a limit to which resistance can be decreased simply by selecting a different material. Moreover, increasing film thickness in order to reduce resistance increases manufacturing time and decreases manufacturing efficiency. The solution in case (B) is limited by the layout of the wiring lines on the second substrate 12. In other words, increasing the number of ground pads 124 used, increasing the area of each of the ground pads 124, or increasing the cross-sectional area of the ground line 125 reduces the degree of freedom in designing the second substrate 12. In case (C), the more the width of the metal film 142 is increased, or the more the number of edges along which the metal film 142 is formed is increased, the more difficult it becomes to make the frame of the display device 10 more narrow.

For these reasons, it does not make sense to reduce the shield resistance more than necessary. Therefore, the shield resistance value necessary to make the surface noise less than or equal to 1V was tested next.

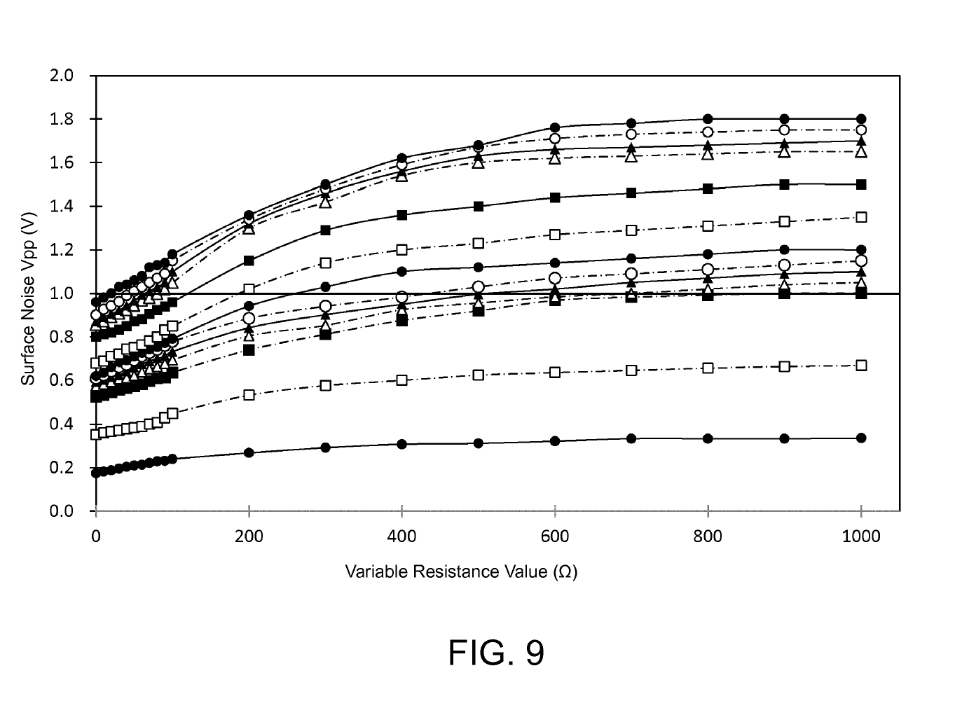

The shield resistance value necessary to make the surface noise less than or equal to 1V depends on the magnitude of noise generated (that is, the noise level). Using once again the measuring environment depicted in FIG. 7, the shield resistance value necessary to make the surface noise less than or equal to 1V was tested for a variety of noise levels. FIG. 9 is a graph illustrating the relationship between the resistance value to which the variable resistance unit 94 was set and the surface noise Vpp for a variety of amplitudes of square waves that were applied to the metal plate 93. This corresponds to the relationship between the shield resistance and the surface noise Vpp in the display device 10 for each noise level.

As shown in FIG. 9, when a square wave having an amplitude large enough to make the surface noise Vpp equal to 1.8V when using a variable resistance value of 1000Ω is applied to the metal plate 93, the variable resistance must be decreased to a value less than or equal to 20Ω in order to make the surface noise Vpp less than or equal to 1V. Similarly, when a square wave having an amplitude large enough to make the surface noise Vpp equal to 1.7V when using a variable resistance value of 1000Ω is applied to the metal plate 93, the variable resistance must be decreased to a value less than or equal to 40Ω in order to make the surface noise Vpp less than or equal to 1V.

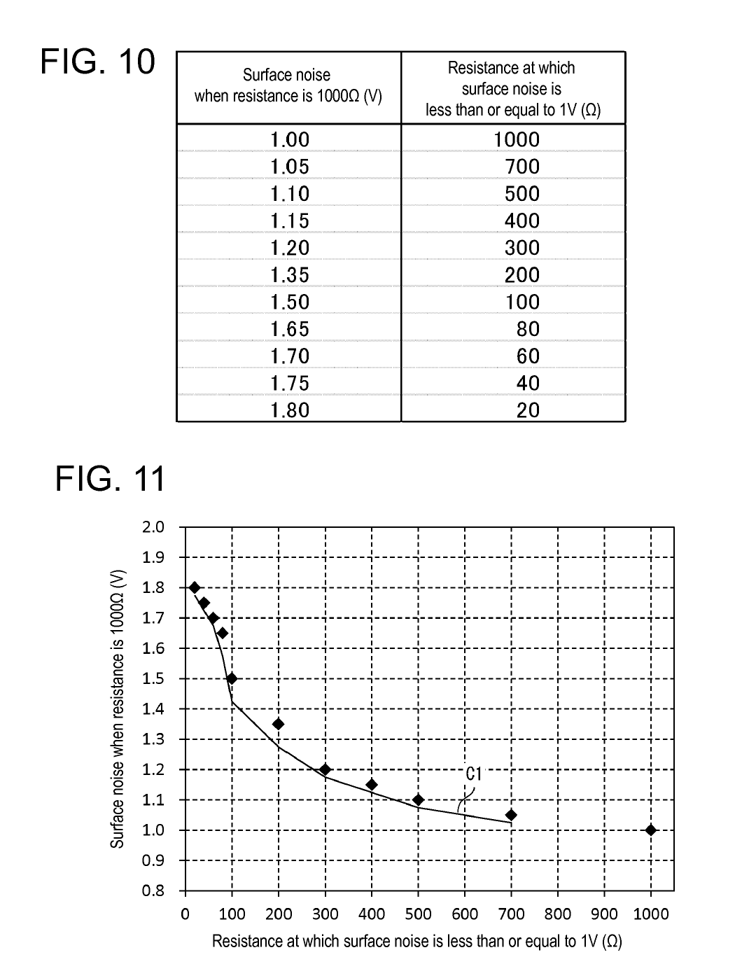

FIG. 10 is a table of variable resistance values for the variable resistance unit 94 at which the surface noise Vpp was less than or equal to 1V when a square wave of a prescribed amplitude was applied to the metal plate 93 and the variable resistance value was progressively decreased. FIG. 11 is a graph of the information in FIG. 10.

As shown in FIGS. 10 and 11, when the noise level is greater than 1.00V and less than or equal to 1.05V, the display device 10 should be designed such that the shield resistance is less than 1000Ω in order to make the magnitude of the surface noise in the display device 10 less than or equal to 1V.

Similarly, when the noise level is greater than 1.05V and less than or equal to 1.10V, the display device 10 should be designed such that the shield resistance is less than 700Ω. When the noise level is greater than 1.10V and less than or equal to 1.15V, the display device 10 should be designed such that the shield resistance is less than 500Ω. When the noise level is greater than 1.10V and less than or equal to 1.15V, the display device 10 should be designed such that the shield resistance is less than 400Ω. When the noise level is greater than 1.20V and less than or equal to 1.35V, the display device 10 should be designed such that the shield resistance is less than 300Ω. When the noise level is greater than 1.35V and less than or equal to 1.50V, the display device 10 should be designed such that the shield resistance is less than 200Ω. When the noise level is greater than 1.50V and less than or equal to 1.65V, the display device 10 should be designed such that the shield resistance is less than 100Ω. When the noise level is greater than 1.65V and less than or equal to 1.70V, the display device 10 should be designed such that the shield resistance is less than 80Ω. When the noise level is greater than 1.70V and less than or equal to 1.75V, the display device 10 should be designed such that the shield resistance is less than 60Ω. When the noise level is greater than 1.75V and less than or equal to 1.80V, the display device 10 should be designed such that the shield resistance is less than 40Ω. When the noise level is greater than 1.80V, the display device 10 should be designed such that the shield resistance is less than 20Ω.

More specifically, first a prototype of the display device 10 is created, and then the shield resistance and surface noise Vpp are measured. Then, the shield resistance value at which the surface noise Vpp of the display device 10 will be less than or equal to 1V is determined using the information in FIGS. 9 to 11. Next, parameters such as the following are adjusted to achieve the shield resistance value determined above: (A) the resistance of the transparent conductive film 141, the metal film 142, the conductive paste members 123, the ground pads 124, and the ground line 125; (B) the number of ground pads 124, the area of each ground pad 124, and the cross-sectional area of the ground line 125; (C) the width of the metal film 142 and the number of edges along which the metal film 142 is formed.

If the shield resistance is 1000Ω and the surface noise is 1.10V in the prototype, for example, then the parameters in groups (A) to (C) should be adjusted such that the shield resistance is less than or equal to 500Ω.

In FIG. 11, the curve C1 represents the relationship between the noise level in the display device 10 and the 2-interval moving average of the shield resistance value at which the surface noise Vpp is less than or equal to 1V. As shown in FIG. 11, the shielding effect of the shield layer improves drastically when the shield resistance is less than 100Ω. Therefore, it is preferable that the shield resistance be less than 100Ω. It is more preferable that the shield resistance be less than 50Ω.

### Other Embodiments

An embodiment of the present invention was described above; however, the present invention is not limited to the embodiment described above, and various modifications can be made without departing from the scope of the claims.

In the embodiment described above, the display device was an IPS liquid crystal display device. However, the driving scheme employed in the display device is not limited to the IPS scheme. The display device may be a liquid crystal display device in which a common electrode is provided on the first substrate, for example. Moreover, the present invention is not limited to applications in liquid crystal display devices and may be applied to any display device in which two substrates are disposed facing one another.

### INDUSTRIAL APPLICABILITY

The present invention is suitable for use in display devices and touch panel-equipped display devices.

1. A display device, comprising:
a first substrate;
a second substrate facing the first substrate, the first and second substrates performing image display by applying time-varying electromagnetic fields;
a shield layer provided on a surface of the first substrate opposite to the second substrate; and
a ground terminal electrically connected to the shield layer,
wherein the shield layer comprises:
a transparent conductive film; and
a metal film formed on at least one portion of a periphery of the first substrate such that the metal film contacts the transparent conductive film, and
wherein a shield resistance, being defined as a maximum resistance value between the ground terminal and any point on the transparent conductive film, is less than 1000Ω so that noise generated on the transparent conductive film caused by the time-varying electromagnetic fields at the first and second substrates is less than or equal to 1V in peak-to-peak voltage amplitude.

2. The display device according to claim 1,
wherein the transparent conductive film has a rectangular shape, and
wherein the metal film is formed along one, two, or three edges of the first substrate.

3. The display device according to claim 1, wherein the shield resistance is less than or equal to 100Ω.

4. A touch panel-equipped display device, comprising:
the display device according to claim 1; and
a touch panel.

5. The display device according to claim 2, wherein the shield resistance is less than or equal to 100Ω

6. A touch panel-equipped display device, comprising:
the display device according to claim 2; and
a touch panel.

7. A touch panel-equipped display device, comprising:
the display device according to claim 3; and
a touch panel.

8. A touch panel-equipped display device, comprising:
the display device according to claim 5; and
a touch panel.
